(19) United States
(12) Patent Application Publication
(10) Pub. No.: US 2002/0084931 A1
(43) Pub. Date: Jul. 4, 2002

(54) Fill level meter

(76) Inventor: Achim Bletz, Tournon sur Rhone (FR)

Correspondence Address: CESARI AND MCKENNA, LLP, 88 BLACK FALCON AVENUE, BOSTON, MA, 02210, US

(21) Appl. No.: 10/054,217

(22) Filed: Nov. 13, 2001

(30) Foreign Application Priority Data
Nov. 13, 2000 (DE) 100 56 099.7
Jan. 15, 2001 (DE) 101 01 714.6

(51) Int. Cl. G01S 13/08; G01F 23/284

(52) U.S. Cl. 342/124; 342/175; 73/290 R

(57) ABSTRACT

A fill level measuring arrangement with a fill level meter, and a vessel (1), whereby the fill level meter operates on the radar principle, for measuring the fill level of a medium (2) in the vessel (1) and an electrical conductor arrangement (3) with a signal generator for generating and transmitting an electromagnetic signal, the conductor arrangement (3) extending into the vessel (1) and at least to a region at the bottom (4) of the vessel (1), the signal generator being positioned at the end of the conductor arrangement (3) which is outside the medium (2) so that the signal produced by the signal generator can be coupled into the conductor arrangement (3) at the end located outside the medium (2). In accordance with the invention it is provided that the transit time of the electromagnetic signal from the signal generator to the region of the vessel bottom (4) is smaller than the transit time of the electromagnetic signal from the signal generator to the end of the conductor arrangement (3) located in the vessel (1) so that the largest possible operating range is achieved which practically extends up to the bottom (4), whereby the lower dead region is virtually eliminated.

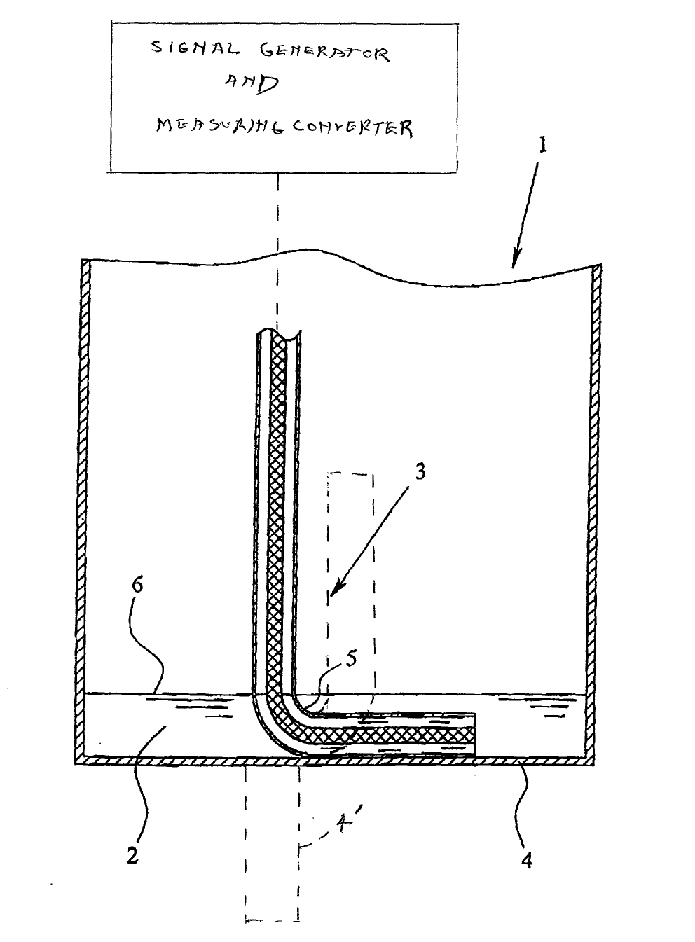

### BACKGROUND OF THE INVENTION

1. Field of the Invention

The invention relates to fill level measuring arrangements, with a fill level meter and a vessel. In particular, the invention relates to fill level meters operating according to the radar principle. The invention further relates to fill level meters which operate according to the radar principle, for the measurement of the fill level of the medium in a vessel.

2. Background Information

Fill level meters operating on the radar principle for the measurement of the fill level of a medium in a vessel generally include a signal generator for producing and transmitting an electromagnetic signal as well as an electrical conductor arrangement, the signal generator being positioned at an end of the conductor arrangement which is outside the medium, so that the signal generated by the signal generator can be coupled into the conductor arrangement at the end provided outside the medium, and the conductor arrangement extends into the vessel and at least up to the region of the vessel bottom.

Conventional fill level meters generally include a signal generator for producing and transmitting an electromagnetic signal and an electrical conductor arrangement, the signal generator being positioned at an end of the conductor arrangement which is outside the medium, so that the signal generated by the signal generator can be coupled into the conductor arrangement at the end provided outside the medium.

The measuring process of such a fill level measuring arrangement or fill level meter, which operates on the radar principle, is based on the TDR measurement principle (Time Domain Reflectometry), which is known, for example, from cable testing and has similarities with the function of radar devices. For example, in such a TDR fill level meter, an extremely short electrical impulse is sent into a vessel through an essentially linearly extending electrical conductor arrangement, in which vessel is found a medium such as a liquid, a powder or a granulate, the fill level of which is to be determined. A conductor arrangement is thereby typically provided which extends into the medium and has two side-by-side, generally parallel conductors. An electrical impulse sent into such an electrical conductor arrangement thereby runs virtually “between” the two conductors into the vessel and is then reflected by the surface of the medium, whereby the reflected portion of the short electrical impulse is again detected by a measurement converter. The reflected portion of the short electrical impulse is dependent on the dielectric constant of the medium and increases with the latter. The transit time of the signal is thereby proportional to the distance of the impulse generator or the measurement converter from the surface of the medium in the vessel. Changing ambient conditions, such as a rising or falling ambient pressure or a rising and falling temperature do not impede the measurement accuracy of the TDR fill level measuring device. Furthermore, the transit time of the signal is independent of the dielectric constant of the medium the level of which is to be determined.

With conventional fill level measuring devices which operate on the radar principle, the determination of the fill level of the medium in a vessel is only possible within a so-called operating range, which—in the case of a signal generator positioned directly at the upper limit of the vessel—extends from immediately below the signal generator down to the region of the vessel bottom, but ends at a certain distance above the vessel bottom. The maximum operating range is then achieved when the conductor arrangement, with that end found in the vessel extends to closely adjacent the vessel bottom. Then, the lower limit of the operating range is set in that the surface of the medium which is located below the limit of the operating range only leads to a reflection of the electromagnetic signal originating from the signal generator which is overlaid by the reflection of the electromagnetic signal which occurs at the end of the conductor arrangement. In general, the reflection of the signal originating from the signal generator and occurring at the end of the conductor arrangement is so large that all other reflection effects found in the region of this reflection, especially the reflected portion of the electromagnetic signal originating from the surface of the medium are completely covered thereby.

The region under the lower limit of the operating range down to the bottom of the vessel, in which the before described covering effect occurs, is called lower dead region. The height of the lower dead region, i.e. its extent from the bottom of the vessel upward, depends, among other things, upon the dielectric constant of the material in the vessel, the duration of the electromagnetic signal produced and transmitted by the signal generator, and the type of the end of the conductor arrangement. Furthermore, the height of the lower dead region depends on the wave resistance of the conductor arrangement.

In the prior art, different efforts have been made to eliminate or at least reduce the lower dead region. One has proceeded, for example, in that the signal produced by the reflection, at the end of the conductor arrangement, of the electromagnetic signal emanating from the signal generator is detected by the measuring converter, is kept in the memory of the electronic measuring converter which carries out the analysis of the detected reflected signals so that this signal expected because of the reflection at the end of the conductor arrangement can be subtracted from the actually measured signal. This process functions, then, reasonably reliably when a lower dead region of a few centimeters is still tolerable. However, this process is strongly influenced by the signal to noise ratio of the whole fill level measurement arrangement and correspondingly limited.

### SUMMARY OF THE INVENTION

It is therefore an object of the invention to provide such a fill level measuring arrangement or such a fill level meter which has the largest possible operating region reaching practically to the bottom of the vessel so that the lower dead region is almost eliminated.

The fill measuring arrangement in accordance with the invention with which the before deduced and described object is solved is characterized according to a first teaching of the invention in that the transit time of the electromagnetic signal from the signal generator to the region of the vessel bottom is less than the transit time of the electromagnetic signal from the signal generator to the end of the electrical conductor arrangement in the vessel.

By provision of the measure in accordance with the invention described above, the signal originating from the reflection at the end of the conductor arrangement is always detected significantly later in time than those signals which are generated by reflections at the surface of the medium, even when the medium is only at a very low fill level. A further development of the invention is thereby preferred wherein the total length of the conductor arrangement from the signal generator to the end found in the vessel is greater than the length of the conductor arrangement from the signal generator to the region of the vessel bottom.

According to another preferred embodiment of the invention, it is provided that the conductor arrangement extends into the bottom of the vessel. Thus, a recess must be provided for this preferred embodiment of the invention in the vessel bottom so that the conductor arrangement can be made sufficiently long without having a conductor arrangement with a portion extending parallel to the vessel bottom or an upwardly directed bend.

Principally, different paths of the conductor arrangement are possible from the signal generator to the region of the vessel bottom, whereby for an easy analysis of the signals reflected at the surface of the medium, it is generally ensured that the conductor arrangement extends essentially straight in the vessel. According to a preferred further development of the invention, it is then provided that the conductor arrangement in the region of the vessel bottom has a bend. According to this preferred embodiment of the invention, a total length of the conductor arrangement from the signal generator to the end thereof found in the vessel is greater than the length of the path of the conductor arrangement to the region at the vessel bottom which is realized in that the conductor arrangement is guided in another direction where the conductor arrangement cannot extend further into the vessel, namely at the bottom of the vessel.

It is thereby principally possible to guide the conductor arrangement in parallel to the bottom of the vessel or in a three-dimensional upward angle. According to a preferred further embodiment, it is provided that the conductor arrangement after the bend extends essentially parallel to the bottom of the vessel or alternatively parallel to its portion before the bend. According to the before mentioned first alternative, the conductor arrangement can be positioned in the vessel in such a way that it rests with its lowermost portion on the bottom of the vessel. According to the before mentioned second alternative, it is possible, for example, to realize the bend of the conductor arrangement in that the lowermost portion of the conductor arrangement is flipped onto the preceding portion and fastened thereto. It can thereby be advantageous, depending on the installation situation, that the conductor arrangement has a rigid, i.e. stiff, bend or a flexible bend.

If the conductor arrangement extends straight and vertical in the vessel, and when the signal generator is provided directly at the upper end of the vessel, the above mentioned measure of the invention is especially easily achieved according to a preferred embodiment of the invention in that a fill level measurement device with a conductor arrangement is used which has a length from the signal generator to the end in the vessel which is greater than the height of the vessel.

Multiple individual constructions or further developments are possible for the exemplary embodiments of the fill level measuring arrangement or the fill level meter according to the invention. However, the scope of the invention is not limited to the embodiments described but is defined solely by the claims appended hereto.

### BRIEF DESCRIPTION OF THE DRAWING

The invention will now be described in more detail by way of example only and with reference to the enclosed drawing figure which is a cross-section through a conductor arrangement of a fill level measuring arrangement positioned in a vessel according to a first exemplary embodiment of the invention.

### DETAILED DESCRIPTION OF AN ILLUSTRATIVE EMBODIMENT

A vessel 1 is schematically apparent from the drawing figure, into which a medium 2 is filled. An electrical conductor arrangement 3 extends from above into this vessel 1 and down to the bottom (4) of the vessel (1). The conductor arrangement 3 is a coaxial conductor arrangement, wherein an inner conductor is surrounded by an outer conductor, whereby the medium to be measured 2 enters in between the inner and outer conductors, since the lower end of the electrical conductor arrangement 3 is at least partially open. In the region of the vessel bottom 4, the conductor arrangement 3 has a bend 5.

After this bend 5, the conductor arrangement 3 extends along the vessel bottom 4. It could also extend back up parallel to the portion preceding the bend as shown in phantom in the drawing. The arrangement 3 could just as well extend straight down into a vessel bottom recess shown in phantom at 4′ in the drawing.

In the situation illustrated in the drawing figure, the medium 2 has only a low fill level so that its surface 6 is located very little above the vessel bottom 4. A signal originating from the a signal generator is now partially reflected at the location at which the conductor arrangement 3 penetrates the surface 6 or where the surface of the medium is located in the electrical conductor arrangement 3 between the inner and outer conductors, which reflection is reflected back to the a measuring converter. This reflection originating from the surface 6 of the medium 2 is now not disturbed or overlapped by the signal produced by a reflection of the signal originating from the signal generator and reflected at the end of the electrical conductor arrangement 3, since the path to be covered by the signal to the end of the electrical conductor arrangement 3 is longer than to the bottom 4 of the vessel 1. The signal originating from the reflection at the end of the conductor arrangement 3 is thereby detected significantly after the signal originating from the surface 6 of the medium 2 and permits a conclusion on the fill level of the medium 2 in the vessel 1.

What is claimed is:

1. A fill level measuring arrangement for measuring the fill level of a medium in a vessel, comprising a vessel having a bottom and a fill level meter operating on the radar principle, said meter including an electrical conductor arrangement having first and second ends and extending into the vessel at least to a region of the vessel bottom, and a signal generator for generating and transmitting an electromagnetic signal, the signal generator being positioned at the first end of the conductor arrangement which is outside the medium so that the signal produced by the signal generator can be coupled into the conductor arrangement at the first end of the conductor arrangement, the transit time of the electromagnetic signal from the signal generator to the region of the vessel bottom being smaller than the transit time of the electromagnetic signal from the signal generator to the second end of the conductor arrangement which is located in the vessel.

2. The fill level measuring arrangement according to claim 1, wherein the total length of the conductor arrangement from the signal generator to the second end is greater than the length of the conductor arrangement from the signal generator to the region at the bottom of the vessel.

3. The fill level measuring arrangement according to claim 2, wherein the conductor arrangement extends essentially straight, up to the region of the bottom of the vessel and has a bend in the region of the bottom of the vessel.

4. The fill level measuring arrangement according to claim 3, wherein the conductor arrangement extends essentially parallel to the bottom of the vessel beyond the bend.

5. The fill level measuring arrangement according to claim 3, wherein the conductor arrangement beyond the bend extends essentially parallel to its portion preceding the bend.

6. The fill level measuring arrangement according to claim 2, wherein the conductor arrangement extends into the bottom of the vessel.

7. The fill level measuring arrangement according to claim 1, wherein the length of the conductor arrangement from the signal generator to its second end located in the vessel is greater than the height of the vessel.
